(19) United States
(12) Patent Application Publication
(10) Pub. No.: US 2022/0261755 A1
(43) Pub. Date: Aug. 18, 2022

(54) DELIVERY CANDIDATE PROPOSAL SYSTEM, DELIVERY CANDIDATE PROPOSAL TERMINAL, AND DELIVERY CANDIDATE PROPOSAL PROGRAM

(71) Applicant: AISIN CORPORATION, Kariya, Aichi (JP)

(72) Inventors: Takaaki NAKAYAMA, Kariya-shi, Aichi-ken (JP); Yoichi YAMAMURA, Kariya-shi, Aichi-ken (JP); Yasuhito YAMADA, Kariya-shi, Aichi-ken (JP); Toyohide TSUBOI, Kariya-shi, Aichi-ken (JP)

(73) Assignee: AISIN CORPORATION, Kariya, Aichi (JP)

(21) Appl. No.: 17/626,738

(22) PCT Filed: Apr. 2, 2020
(86) PCT No.: PCT/JP2020/015140

§ 371 Date: Jan. 12, 2022

(30) Foreign Application Priority Data
Sep. 12, 2019 (JP) 2019-165799

(51) Int. Cl. G06Q 10/08

(52) U.S. Cl. CPC G06Q 10/08345; G06Q 10/08355

(57) ABSTRACT

To provide a system that can figure out whether a profit is made by delivery. A delivery candidate proposal system is configured to include a current location obtaining part that obtains a current location of a delivery vehicle; a delivery information obtaining part that obtains a loading location, a delivery location, and a delivery charge for a delivery candidate package; a cost obtaining part that obtains costs required when the delivery candidate package is delivered to the delivery location on the delivery vehicle, based on the current location, the loading location, and the delivery location; and a guidance control part that allows a guidance part to provide guidance on information indicating a profit obtained by subtracting the costs from the delivery charge, with the delivery candidate package.

### CROSS REFERENCE TO RELATED APPLICATIONS

This application is a National Stage application of International Application No. PCT/JP2020/015140 filed Apr. 2, 2020, which designates the United States, incorporated herein by reference, and which claims the benefit of priority from Japanese Patent Application No. 2019-165799 filed Sep. 12, 2019, the entire contents of which are incorporated herein by reference.

### TECHNICAL FIELD

The present disclosure relates to a delivery candidate proposal system, a delivery candidate proposal terminal, and a delivery candidate proposal program.

### BACKGROUND ART

Conventionally, there is known a system that performs matching between a shipper who wants a package to be delivered and a delivery person. For example, Patent Literature 1 discloses a technique in which a desired delivery amount is computed based on attribute information of a package and an agent commission rate, and is notified to a vehicle owner.

### CITATIONS LIST

### Patent Literature

Patent Literature 1: JP 2003-30481 A

### SUMMARY I/F THE DISCLOSURE

### Technical Problems

In the conventional technique, it has been unknown whether a driver of a delivery vehicle makes a profit by him/her accepting a delivery request. When a package is delivered on the delivery vehicle, there is a need to at least travel from a current location to a loading location and travel from the loading location to a delivery location. A travel distance in this case varies depending on the package, and thus, costs required for the delivery can vary depending on the package. Thus, if whether the driver makes a profit by delivering a package is unknown, then it is difficult for the driver to determine whether he/she should accept a request for delivery of a package.

The present disclosure is made in view of the above-described problem, and provides a system that can figure out whether a profit is made by delivery.

### Solutions to Problems

To provide the above-described system, a delivery candidate proposal system includes: a current location obtaining part that obtains a current location of a delivery vehicle; a delivery information obtaining part that obtains a loading location, a delivery location, and a delivery charge for a delivery candidate package; a cost obtaining part that obtains costs required when the delivery candidate package is delivered to the delivery location on the delivery vehicle, based on the current location, the loading location, and the delivery location; and a guidance control part that allows a guidance part to provide guidance on information indicating a profit obtained by subtracting the costs from the delivery charge, with the delivery candidate package.

In addition, a delivery candidate proposal terminal includes: a current location transmitting part that transmits a current location of a delivery vehicle; a receiving part that receives information indicating a relationship between costs and a delivery charge, and a delivery candidate package, the costs being obtained based on a loading location, a delivery location, and the delivery charge for the delivery candidate package, and being required when the delivery candidate package is delivered to the delivery location on the delivery vehicle; and a guidance part that provides guidance on information indicating a profit obtained by subtracting the costs from the delivery charge, with the delivery candidate package.

Furthermore, a delivery candidate proposal program causes a computer to function as: a current location obtaining part that obtains a current location of a delivery vehicle; a delivery information obtaining part that obtains a loading location, a delivery location, and a delivery charge for a delivery candidate package; a cost obtaining part that obtains costs required when the delivery candidate package is delivered to the delivery location on the delivery vehicle, based on the current location, the loading location, and the delivery location; and a guidance control part that allows a guidance part to provide guidance on information indicating a profit obtained by subtracting the costs from the delivery charge, with the delivery candidate package.

Namely, the delivery candidate proposal system, the delivery candidate proposal terminal, and the delivery candidate proposal program can provide guidance on a relationship between costs required when a delivery candidate package is delivered to a delivery location on a delivery vehicle, and a delivery charge. According to the relationship, whether a profit is made by the delivery is figured out. Thus, a user such as a driver can determine whether to accept a delivery request, based on whether there is a profit, size, etc.

### BRIEF DESCRIPTION I/F DRAWINGS

FIG. 1 is a block diagram of a delivery candidate proposal system.

FIG. 2 is a flowchart of a matching process.

FIG. 3 is a flowchart of a profit obtaining process.

FIGS. 4A, 4B, and 4C are diagrams showing exemplary display on a driver terminal.

### DESCRIPTION I/F EMBODIMENTS

Here, embodiments of the present disclosure will be described in accordance with the following order:

(1) Configuration of a delivery candidate proposal system;

(2) Matching process;

(3) Profit obtaining process; and

(4) Other embodiments.

### (1) Configuration of a Delivery Candidate Proposal System

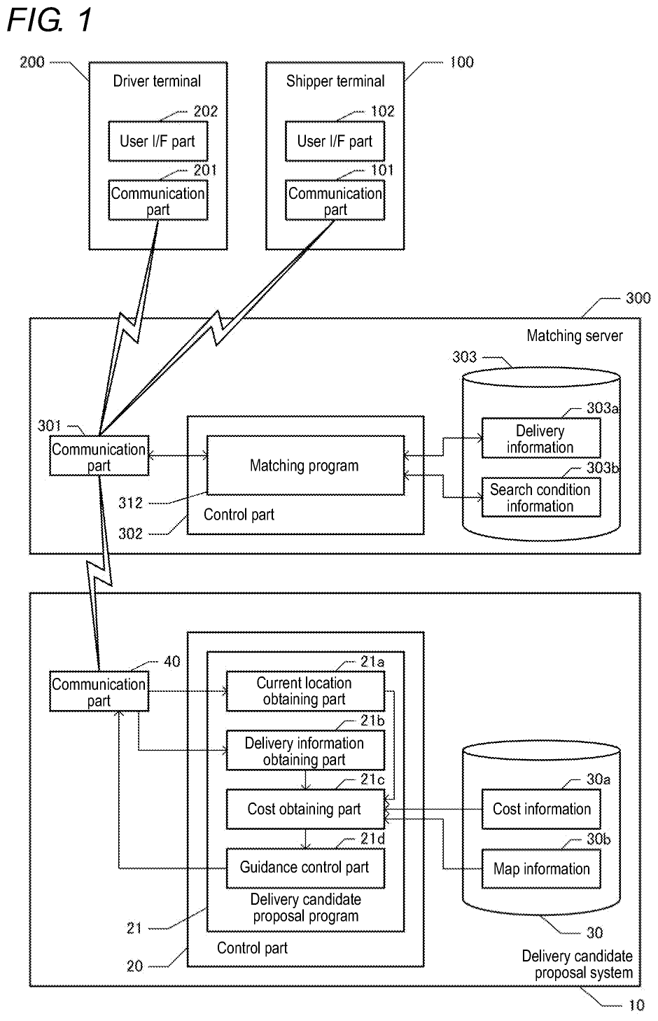

FIG. 1 is a block diagram showing a configuration of a delivery candidate proposal system 10 according to an embodiment. In the present embodiment, a plurality of computers cooperate with each other for matching of needs between a shipper who wants a package to be delivered from a loading location to a delivery location and a driver who accepts delivery of a package and performs the delivery on a delivery vehicle. The shipper has a shipper terminal 100 and can request delivery of a package by operating the shipper terminal 100. The shipper terminal 100 is a general-purpose computer and in the present embodiment, the shipper terminal 100 is assumed to be a portable terminal such as a smartphone or a tablet terminal. Needless to say, the shipper terminal 100 may be a stationary computer.

The driver has a driver terminal 200 and can accept a request for delivery of a package by operating the driver terminal 200. The driver terminal 200 is a general-purpose computer and in the present embodiment, the driver terminal 200 is assumed to be a portable terminal such as a smartphone or a tablet terminal. Needless to say, the driver terminal 200 may be a stationary computer such as an in-vehicle computer. Note that although, in the present embodiment, the driver of the delivery vehicle accepts delivery of a package using the driver terminal 200, for example, a mode may be employed in which a person other than the driver of the delivery vehicle accepts delivery of packages and allows the driver to deliver a package based on information about the accepted delivery.

The shipper terminal 100 and the driver terminal 200 can communicate with a matching server 300. The matching server 300 accumulates pieces of information about packages which are transmitted from the shipper terminal 100. In addition, the matching server 300 retrieves information about packages in response to a search performed on the driver terminal 200, and transmits the information to the driver terminal 200. The matching server 300 provides information about packages in response to a search thus performed by the driver, and thereby performs matching between the shipper and the driver.

To implement such matching, the shipper terminal 100 includes a communication part 101, a user I/F part 102, and a control part which is not shown. The communication part 101 includes a circuit that can communicate with the matching server 300. The user I/F part 102 is an interface part for providing the shipper with various types of information and inputting information on a package, etc., and in the present embodiment, the user I/F part 102 is a touch panel display.

The control part can execute a program which is not shown, and the shipper can request delivery of a desired package by executing the program. Namely, the shipper inputs information about a package which is a delivery request target, by operating the user I/F part 102. The information about a package may include various types of information, and in the present embodiment, the information about a package is information indicating the loading location, delivery location, delivery charge, loading date and time, and delivery date and time of the package, and the weight and size of the package. Needless to say, the information about a package may also include other various types of information and may include, for example, the type of the package. When the shipper inputs the information about a package, the shipper terminal 100 transmits the information about a package to the matching server 300 through the communication part 101.

The driver terminal 200 includes a communication part 201, a user I/F part 202, and a control part which is not shown. The communication part 201 includes a circuit that can communicate with the matching server 300. The user I/F part 202 is an interface part for providing the driver with various types of information such as candidates for delivery of packages, and inputting acceptance of delivery of a package, and in the present embodiment, the user I/F part 202 is a touch panel display. In the present embodiment, the user I/F part 202 corresponds to a guidance part.

The control part can execute a program which is not shown, and the driver can perform a package search and acceptance of delivery by executing the program. Namely, the driver inputs conditions for a package that he/she wants to deliver, by operating the user I/F part 202. The conditions may be various conditions, and in the present embodiment, the conditions are information such as the date and time on which the driver wants to deliver a package, a loading location, a delivery location, and the weight and size of the package. Needless to say, the conditions for a package may also include other various types of information and may include, for example, the type of the package. Note that a search condition may be a condition including a plurality of conditions. For example, a loading location or a delivery location may be specified by an area including a plurality of locations, instead of one specific location. When the driver inputs the search conditions for a package, the driver terminal 200 transmits the search conditions for a package to the matching server 300 through the communication part 201.

The matching server 300 has a function of performing matching between the shipper and the driver. To perform the function, the matching server 300 includes a communication part 301, a control part 302, and a recording medium 303. The control part 302 includes a CPU, a RAM, a ROM, etc., and can execute a matching program 312 recorded in the ROM or the recording medium 303. By executing the matching program 312, the control part 302 waits for the shipper terminal 100 to transmit a delivery request. When information about a package is transmitted from the shipper terminal 100, the control part 302 receives the information about a package through the communication part 301. In addition, the control part 302 records the information about a package as delivery information 303a in the recording medium 303. As a result, pieces of delivery information 303a about packages whose delivery requests have been made are accumulated in the recording medium 303.

In addition, the control part 302 waits for the driver terminal 200 to transmit search conditions for a package. When search conditions for a package are transmitted from the driver terminal 200, the control part 302 receives the search conditions for a package through the communication part 301. The control part 302 associates the received search conditions with identification information of the driver, and records the search conditions as search condition information 303b in the recording medium. Furthermore, the control part 302 obtains, as delivery candidates, packages that match the search conditions by referring to the delivery information 303a. The search conditions include at least any one of, for example, the date and time on which the driver wants to deliver a package, a loading location, a delivery location, and the weight and size of the package. Hence, the control part 302 obtains packages that match conditions specified as the search conditions among the above-described conditions from the delivery information 303a, and considers the packages as delivery candidate packages.

When the delivery candidates are obtained, the control part 302 transmits information indicating the delivery candidate packages to the driver terminal 200 having transmitted the search conditions, through the communication part 301. As a result, the driver terminal 200 allows the user I/F part 202 to display the information indicating the delivery candidate packages. The driver selects a package that he/she wants to deliver, based on the display of the delivery candidate packages. When a package is selected, the driver terminal 200 transmits the selected package with the identification information of the driver through the communication part 201.

The control part 302 receives the selected package through the communication part 301. Then, the control part 302 associates the selected package with the identification information of the driver, and transmits to the shipper terminal 100 through the communication part 301 information indicating that a request for delivery of the package has been accepted, with the identification information of the driver. In addition, the control part 302 transmits to the driver terminal 200 through the communication part 301 information indicating that the acceptance of the delivery request has been confirmed.

As described above, according to the matching server 300, matching between the shipper and the driver can be performed. Upon performing matching, the matching server 300 allows the user I/F part 202 of the driver terminal 200 to display information indicating delivery candidate packages, and thereby provides the driver with options. The display on the user I/F part 202 is display showing delivery candidate packages in a selectable manner. The display can be performed in various modes. However, it is difficult to select a delivery candidate only by simply displaying the loading location, delivery location, loading date and time, and delivery date and time of a package, the weight and size of the package, and a delivery charge which are pieces of information required for delivery.

Namely, even with the same delivery charge, if a route required for delivery is long, then a profit decreases. The profit can vary depending on the situation of the driver (e.g., a current location or the time and effort taken when a package is added to an existing plan). Thus, if a profit made by delivery is unknown, then it is difficult for the driver to determine whether he/she should accept a delivery request.

Hence, in the present embodiment, the delivery candidate proposal system 10 performs a process for proposing a profit made by delivering a delivery candidate package, in accordance with a delivery candidate. To do so, the delivery candidate proposal system 10 includes a control part 20, a recording medium 30, and a communication part 40. The communication part 40 includes a circuit that can communicate with the matching server 300.

The recording medium 30 records therein cost information 30a and map information 30b. The cost information 30a is information indicating various parameters required to compute delivery costs. In the present embodiment, there are included information indicating an energy cost per unit travel distance of the delivery vehicle, information indicating an increase in travel cost caused by a change of a road, and information indicating a toll for a road. The energy cost per unit travel distance of the delivery vehicle may have a value that varies from delivery vehicle to delivery vehicle or may have a value that varies from driver to driver. In the present embodiment, for simplicity, description is made assuming that the energy cost per unit travel distance is the same for a plurality of delivery vehicles.

The information indicating an increase in travel cost caused by a change of a road is information for computing an amount by which the travel cost increases with an increase in the amount of energy consumed, compared with a case of a flat, straight road. For example, when, due to the presence of a gradient, the amount of energy consumed increases compared with a flat, straight road, information from which the increase or increase rate of the amount of energy consumed can be obtained serves as cost information 30a. Needless to say, the degree of change in the amount of energy consumed may vary depending on the magnitude of a gradient, the distance of a gradient road, etc. In the present embodiment, for simplicity, the amount of energy consumed that increases when the gradient of a road has a magnitude exceeding a predetermined range is defined as an increase rate of the amount of energy consumed per unit distance (a rate for the increase). Namely, by multiplying the distance of a gradient section by the rate, an increase from a travel cost for a flat, straight road is obtained. Needless to say, the increase in the amount of energy consumed caused by a gradient may have positive and negative values. Namely, in a case of an upward gradient, the amount of energy consumed may be considered to increase, and in a case of a downward gradient, the amount of energy consumed may be considered to decrease.

In addition, when, due to a road being not straight (being curved), the amount of energy consumed increases compared with a flat, straight road, information from which the increase or increase rate of the amount of energy consumed can be obtained serves as cost information 30a. Needless to say, the degree of change in the amount of energy consumed may vary depending on the radius of curvature of a curve, the distance of a curved section, etc. In the present embodiment, for simplicity, the amount of energy consumed that increases when the radius of curvature of a curve is less than or equal to a threshold value is defined as an increase rate of the amount of energy consumed per unit distance (a rate for the increase). Namely, by multiplying the distance of a curved section by the rate, an increase from a travel cost for a flat, straight road is obtained. Furthermore, the cost information 30a includes information indicating a toll for a toll road. The information may be included in the map information 30b.

The map information 30b includes node data representing the locations of nodes set on a road on which vehicles travel, etc.; shape interpolation point data representing the locations of shape interpolation points for identifying the shape of a road between nodes, etc.; link data representing a link between nodes; ground object data representing the locations of ground objects present on a road or around the road, etc.; and the like. In the present embodiment, pieces of link data are associated with link costs, and a route search can be performed by identifying a route with the smallest cumulative total of the link costs. Furthermore, in the present embodiment, a node and a shape interpolation point are associated with information indicating an altitude. Thus, a gradient can be identified based on the difference in altitude and the difference in distance between adjacent nodes or shape interpolation points.

The control part 20 includes a CPU, a RAM, a ROM, etc., which are not shown, and can execute programs recorded in the ROM, the recording medium 30, etc. In the present embodiment, the programs include a delivery candidate proposal program 21. The delivery candidate proposal program 21 includes a current location obtaining part 21a, a delivery information obtaining part 21b, a cost obtaining part 21c, and a guidance control part 21d.

The current location obtaining part 21a is a program module that allows the control part 20 to perform a function of obtaining a current location of the delivery vehicle. In the present embodiment, the current location of the delivery vehicle is identified on the driver terminal 200 and transmitted to the delivery candidate proposal system 10 through the matching server 300. Namely, to obtain a profit for a case of delivering on the delivery vehicle, there is a need to compute costs required for the delivery vehicle to travel. In the present embodiment, it is assumed that costs are incurred by the delivery vehicle starting to move from the current location.

Hence, in the present embodiment, the driver terminal 200 identifies a current location of the delivery vehicle (thus, the driver terminal includes a current location transmitting part). The current location may be identified by various techniques, and for example, the driver terminal 200 may be configured to include a GNSS receiving part, and a current location may be identified by the GNSS receiving part receiving signals from navigation satellites. In addition, a current location may be identified based on an output signal from a vehicle speed sensor or a gyro sensor, or a current location may be identified based on the output signal and an output from the GNSS receiving part. Furthermore, a current location may be inputted by the driver operating the user I/F part 202.

When a current location of the delivery vehicle is identified, the driver terminal 200 transmits the current location of the delivery vehicle to the matching server 300 through the communication part 201. Note that in the present embodiment, the driver has already accepted a request for delivery of a package, and can accept additional delivery of a package in addition to the existing delivery of the package. In this case, the driver terminal 200 holds a route (existing route) for the existing delivery of the package, and upon transmitting the current location of the delivery person's vehicle, the driver terminal 200 transmits the current location, including information indicating the route. At any rate, the matching server 300 receives information indicating the current location (including, when there is an existing route, the route and the total sum of delivery charges for all packages delivered on the existing route. The same applies hereinafter.) through the communication part 301, and records the information as search condition information 303b in the recording medium 303. The information may be used to search for delivery candidate packages.

In the present embodiment, the control part 302 further transmits the current location of the delivery vehicle to the delivery candidate proposal system 10 through the communication part 301. The delivery candidate proposal system 10 obtains the current location of the delivery vehicle through the communication part 40.

The delivery information obtaining part 21b is a program module that allows the control part 20 to perform a function of obtaining the loading location, delivery location, and delivery charge for a delivery candidate package. Namely, the control part 20 makes a request for transmission of delivery information 303a through the communication part 40. The matching server 300 transmits delivery information 303a in response to the transmission request, and the control part 20 obtains the delivery information 303a through the communication part 40. Note that delivery information 303a which is a transmission target may be any information as long as the information is for computing costs required to deliver a package. In the present embodiment, since a route to be traveled for delivery is identified, the delivery information 303a includes at least the loading location, delivery location, and delivery charge for a delivery candidate package as transmission targets.

The cost obtaining part 21c is a program module that allows the control part 20 to perform a function of obtaining costs required when a delivery candidate package is delivered to a delivery location on the delivery vehicle, based on a current location, a loading location, and the delivery location. In the present embodiment, the control part 20 obtains a travel cost based on an energy cost required when the delivery vehicle travels from a current location to a loading location and further travels a route from the loading location to a delivery location. Furthermore, costs other than the energy cost are added and the resulting costs are considered to be costs required for delivery.

Specifically, when there is no existing route, the control part 20 searches for a route along which the delivery vehicle travels from a current location to a loading location and further travels from the loading location to a delivery location, by referring to the map information 30b. When the route is searched, the control part 20 obtains a travel cost for the route based on an energy cost per unit travel distance of the delivery vehicle. Namely, the control part 20 identifies a distance along the route from the current location to the delivery location, based on the map information 30b. Furthermore, the control part 20 obtains an energy cost per unit travel distance of the delivery vehicle by referring to the cost information 30a, multiplies the distance by the energy cost, and thereby obtains a travel cost for the route.

Furthermore, the control part 20 obtains an increase from the travel cost by referring to the cost information 30a and the map information 30b. Specifically, the control part 20 identifies a section of the route whose gradient magnitude exceeds a predetermined range by referring to the map information 30b, and identifies a distance of the section. Then, the control part 20 multiplies a travel cost for the distance by an increase in travel cost caused by the gradient, and thereby obtains a cost for the increase.

Furthermore, the control part 20 identifies a curved section of the route whose radius of curvature is less than or equal to a threshold value by referring to the map information 30b, and identifies a distance of the curved section. Then, the control part 20 multiplies a travel cost for the distance by an increase in travel cost caused by the curve, and thereby obtains a cost for the increase. Furthermore, the control part 20 determines whether the route includes a toll road by referring to the cost information 30a, and when the route includes a toll road, the control part 20 obtains a toll for the toll road. Then, the control part 20 obtains an amount resulting from adding together the travel cost for the route, the increases in travel cost, and the toll, as costs required for delivery.

On the other hand, when the driver terminal 200 holds a route (existing route) for existing delivery of a package, the existing route is transmitted with the current location of the delivery vehicle. In this case, the control part 20 identifies a new route required to deliver a delivery candidate, and obtains costs increased from the existing route due to adoption of the new route. To do so, the control part 20 obtains costs for the existing route by referring to the cost information 30a and the map information 30b. A method of obtaining the costs is the same as a method of obtaining for a case in which there is no existing route.

Furthermore, the control part 20 adds, as new destinations, the loading location and delivery location of the delivery candidate package to destinations of the existing route, and searches for a new route based on the map information 30b. For example, the control part 20 searches, as a new route, for a route that visits the destinations in order of closest to the current location and in the order in which a loading location of a given package comes first and a delivery location of the given package comes later. Furthermore, the control part 20 obtains costs for the new route by referring to the cost information 30a and the map information 30b. A method of obtaining the costs is the same as a method of obtaining for a case in which there is no existing route.

The guidance control part 21d is a program module that allows the control part 20 to perform a function of allowing the guidance part to provide guidance on information indicating a relationship between costs and a delivery charge, with a delivery candidate package. In the present embodiment, the information indicating a relationship between costs and a delivery charge is a profit made by delivery, i.e., the delivery charge−the costs. Hence, the control part 20 obtains a profit by subtracting costs obtained by the cost obtaining part 21c from a delivery charge obtained by the delivery information obtaining part 21b.

Note that when there is an existing route, the control part 20 obtains a profit for the existing route and a profit for a new route, based on costs for the existing route and costs for the new route. Namely, the control part 20 obtains a profit for the existing route by subtracting the costs for the existing route from the total sum of delivery charges for all packages delivered on the existing route. In addition, the control part 20 obtains a profit for the new route by adding a delivery charge for a delivery candidate package to the total sum of delivery charges for all packages delivered on the existing route and further subtracting the costs for the new route therefrom.

In the present embodiment, the control part 20 performs a process of obtaining a profit such as that described above, for a plurality of delivery candidates. Namely, the matching server 300 identifies delivery candidate packages in accordance with search conditions inputted by the driver. Hence, the control part 20 performs, for each of the delivery candidates, the process of obtaining a profit. The control part 20 transmits the profits obtained for the respective delivery candidates to the matching server 300 through the communication part 40. The matching server 300 transmits information indicating the profits for the respective delivery candidates to the driver terminal 200 through the communication part 301. The driver terminal 200 allows the guidance part (touch panel display) of the user I/F part 202 to provide guidance on the profit for each delivery candidate package. Here, guidance may be provided in any manner as long as guidance on the profit is provided for each delivery candidate package, and the delivery candidate packages may be distinguished from each other in various modes. For example, the packages may be distinguished from each other by at least one of the name of a shipper, a loading location, a delivery location, a delivery charge, etc.

When there is an existing route, the control part 20 transmits a difference in profit (the costs for the new route−the costs for the existing route) to the matching server 300 through the communication part 40. The matching server 300 transmits information indicating the difference in profit for each delivery candidate to the driver terminal 200 through the communication part 301. The driver terminal 200 allows the guidance part (touch panel display) of the user I/F part 202 to provide guidance on the difference in profit for each delivery candidate package. Here, too, guidance may be provided in any manner as long as guidance on the difference in profit is provided for each delivery candidate package, and the delivery candidate packages may be distinguished from each other in various modes.

According to the above-described configuration, the driver can determine whether to accept a delivery request, based on a profit for each delivery candidate. In addition, the driver who already has a delivery plan can determine whether to newly accept delivery, by comparing delivery candidates based on profits increased by newly accepting delivery of the delivery candidate packages.

### (2) Matching Process

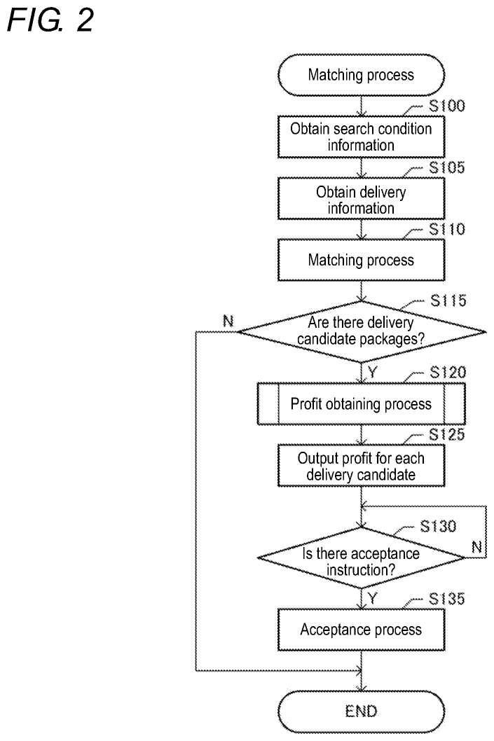

Next, a matching process performed by the matching server 300 will be described. FIG. 2 is a flowchart of the matching process. The matching process is performed when the driver inputs search conditions for a package onto the driver terminal 200 to start a search. Specifically, when the driver inputs search conditions for a package onto the driver terminal 200, search condition information is transmitted to the matching server 300 through the communication part 201. The matching server 300 monitors whether search condition information has been transmitted through the communication part 301, and when search condition information is transmitted, the control part 302 starts a matching process.

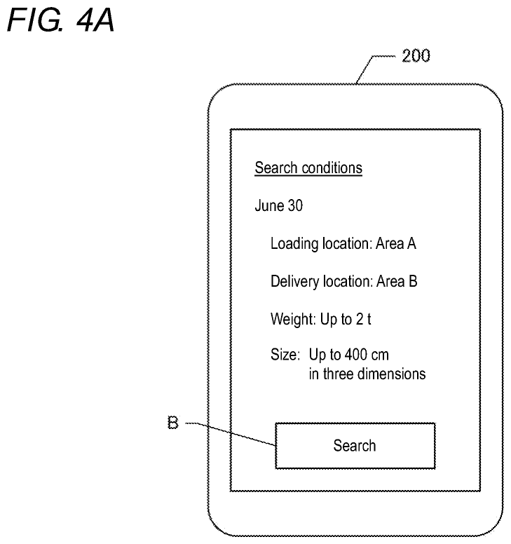

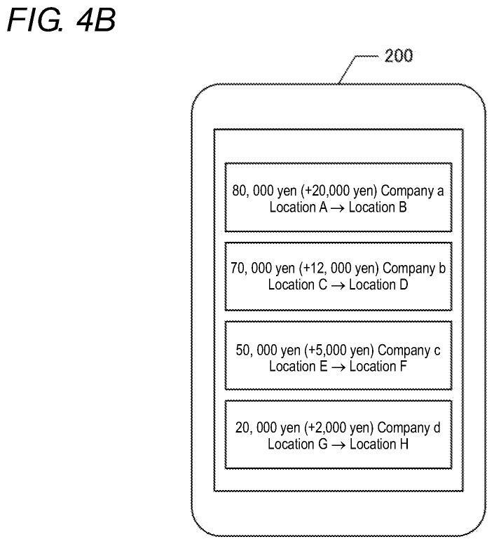

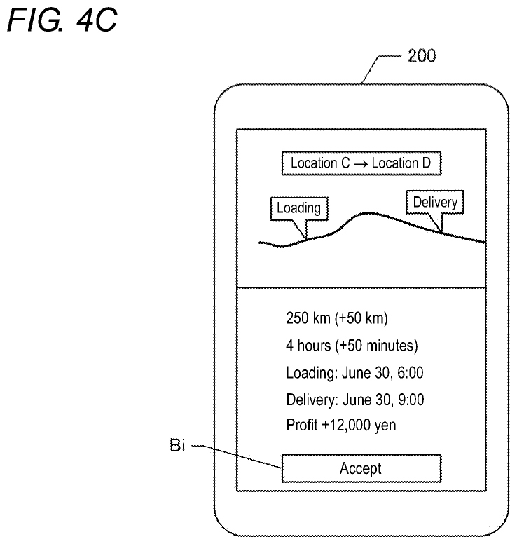

FIG. 4A is a diagram showing exemplary input of search conditions. FIG. 4A shows exemplary display on the user IN part 202 of the driver terminal 200. In this example, the driver can specify a search condition for each item by performing various operations on the user IN part 202. The example shown in FIG. 4A exemplifies a state in which a loading or delivery date, a loading location, a delivery location, the weight of a package, and the size of the package are inputted as search conditions. In addition, FIG. 4A shows an example in which a search button B is displayed, and by the driver tapping the search button B, search condition information is transmitted from the driver terminal 200 to the matching server 300. Note that a range limited by a search condition in each item is adjustable. For example, the loading location shown in FIG. 4A is area A, and all loading locations included in area A having space match the search condition. The loading location may be thus specified by an area or may be specified by coordinates or may be limited by other various techniques.

At any rate, when the search button B is tapped, search condition information is transmitted, and the control part 302 starts a matching process. Then, the control part 302 obtains the search condition information through the communication part 301 (step S100). The obtained search condition information is recorded in the recording medium 303 (search condition information 303b).

Then, the control part 302 obtains delivery information (step S105). Namely, the control part 302 obtains delivery information 303a which is transmitted from the shipper terminal 100 at any timing, and records the delivery information 303a in the recording medium 303. Hence, the control part 302 extracts pieces of information on packages whose delivery has not been accepted, from the pieces of delivery information 303a recorded in the recording medium 303.

Then, the control part 302 performs a matching process (step S110). Namely, the control part 302 identifies packages that match the search conditions obtained at step S100, by referring to the delivery information 303a extracted at step S105. For example, in the example shown in FIG. 4A, a package whose loading or delivery date and time are June 30, whose loading location is area A, whose delivery location is area B, whose weight is 2000 kg or less, and whose overall three dimensional size is 400 cm or less is searched.

Then, the control part 302 determines whether there are delivery candidate packages (step S115). Namely, when pieces of delivery information 303a that match the search conditions are identified in the matching process at step S110, the control part 302 determines that there are delivery candidate packages. If pieces of delivery information 303a that match the search conditions are not identified at step S115, then the control part 20 does not determine that there are delivery candidate packages. In this case, the matching process ends. Needless to say, in this case, information indicating that there is no delivery candidate package may be transmitted to the driver terminal 200 and displayed on the user IN part 202.

If it is determined at step S115 that there are delivery candidate packages, then the control part 302 performs a profit obtaining process for each delivery candidate (step S120). Namely, the control part 302 transmits pieces of delivery information 303a about the delivery candidate packages and a current location of the driver terminal 200 (including, when there is an existing route, the route and the total sum of delivery charges for all packages delivered on the existing route.) to the delivery candidate proposal system 10 through the communication part 301. As a result, the delivery candidate proposal system 10 performs a profit obtaining process. When the profit obtaining process is performed, if there is no existing route, then a profit for each delivery candidate package is obtained, and if there is an existing route, then a difference in profit is obtained for each delivery candidate package. These profits or differences in profit are transmitted from the delivery candidate proposal system 10 to the matching server 300.

The control part 302 outputs the profit (or the difference in profit) for each delivery candidate package (step S125). Namely, the control part 320 transmits pieces of information indicating the delivery candidate packages and the profit (or the difference in profit) made when each package is accepted, to the driver terminal 200 having transmitted the search condition information, through the communication part 301. Note that, in the present embodiment, information indicating a delivery candidate package includes delivery information 303a about the package and information indicating a route for delivering the package. Note that, in the present embodiment, a route search is performed by the delivery candidate proposal system 10.

The driver terminal 200 obtains, through the communication part 201, the pieces of information indicating the delivery candidate packages and the profit made when each package is accepted. Then, the driver terminal 200 allows the user I/F part 202 to display the profit (or the difference in profit) for each delivery candidate package. FIG. 4B is a diagram showing exemplary display of a difference in profit for each package. In FIG. 4B, information about each delivery candidate package is shown in a rectangular box. In addition, for each package, there are shown the total sum of delivery charges for all packages including a delivery candidate package (the total sum of delivery charges for all packages delivered on the existing route+a delivery charge for the new package), a difference in profit, a shipper, a loading location, and a delivery location.

For example, a box at the top shown in FIG. 4B shows that the total sum of delivery charges for all packages is 80,000 yen, the difference in profit is +20,000 yen, the shipper is company a, the loading location is location A, and the delivery location is location B. Note that, for example, a configuration is employed in which upon displaying a profit for each package, in the same display as that of FIG. 4B, instead of the total sum of delivery charges for all packages delivered on a new route and the difference in profit, a delivery charge and a profit for a delivery candidate are shown.

In the present embodiment, when the driver selects a delivery candidate package such as that shown in FIG. 4B, details of the delivery candidate package are displayed. FIG. 4C shows exemplary display of the details of the package. In FIG. 4C, at the top of a screen there are shown a route (represented by a thick solid line) for delivering the package, and the loading location and delivery location of the delivery candidate package. Note that the example shown in FIG. 4C is also an example in which there is an existing route, and thus, the loading location and delivery location of the delivery candidate package are present in the middle of the route, and the driver also delivers another package.

Furthermore, in the example shown in FIG. 4C, there are shown the total distance (250 km) of the route and a distance (+50 km) increased by delivering the delivery candidate package. Furthermore, in the example shown in FIG. 4C, there are shown the total required time period (4 hours) for traveling the route and the required time period (+50 minutes) increased by delivering the delivery candidate package. Furthermore, the date and time on which loading is to be performed and the date and time on which delivery is to be performed are shown, and the difference in profit is also shown. In the example shown in FIG. 4C, a button Bi that gives an instruction for acceptance is also displayed, and the driver can give an acceptance instruction by tapping the button Bi.

Then, the control part 302 determines whether an acceptance instruction has been given (step S130). Namely, when the driver gives an acceptance instruction by operating the user IN part 202 of the driver terminal 200, the driver terminal 200 transmits information indicating an accepted package to the matching server 300 through the communication part 201.

When the control part 302 receives the information indicating an accepted package through the communication part 301, the control part 302 determines that an acceptance instruction has been given, and performs an acceptance process (step S135). Namely, the control part 302 associates information indicating the accepted package among the pieces of delivery information 303a with information indicating “accepted”. Then, the control part 302 transmits information indicating that the acceptance has been completed, to the driver terminal 200 through the communication part 301. As a result, the driver recognizes the completion of the acceptance of delivery of a new package, and performs delivery operations including the new package. In addition, the control part 302 transmits information indicating the completion of acceptance to the shipper terminal 100 through the communication part 301. As a result, the shipper recognizes the acceptance of requested delivery of a package, and hands over the package so that loading can be performed on the requested date and time.

### (3) Profit Obtaining Process

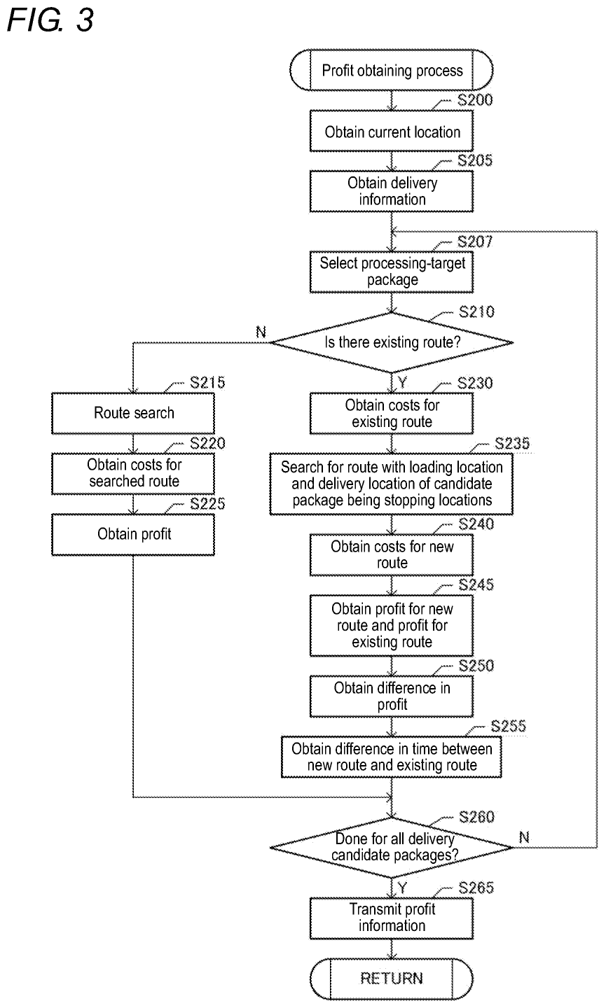

Next, a profit obtaining process performed by the delivery candidate proposal system 10 will be described. FIG. 3 is a flowchart of the profit obtaining process. The profit obtaining process is performed when delivery information 303a and a current location of the driver terminal 200 (including, when there is an existing route, the route and the total sum of delivery charges for all packages delivered on the existing route.) are transmitted from the matching server 300.

When the profit obtaining process starts, the control part 20 the control part 20 obtains a current location (including, when there is an existing route, the route and the total sum of delivery charges for all packages delivered on the existing route.) through the communication part 40 by the function of the current location obtaining part 21a (step S200). In addition, the control part 20 obtains pieces of delivery information 303a through the communication part 40 by the function of the delivery information obtaining part 21b (step S205).

Then, the control part 20 selects a processing-target package (step S207). Namely, since the matching server 300 transmits delivery information 303a for each delivery candidate package, the control part 20 selects one package that is not a target for a loop process at step S210 to S260 from among the delivery candidate packages obtained at step S205.

Then, the control part 20 determines whether there is an existing route, by the function of the cost obtaining part 21c (step S210). Namely, when the current location obtained at step S200 is associated with an existing route, the control part 20 determines that there is an existing route. If it is not determined at step S210 that there is an existing route, the control part 20 performs a route search by the function of the cost obtaining part 21c (step S215). Namely, by referring to the map information 30b, the control part 20 searches, based on the link costs, for a route along which the delivery vehicle travels from the current location to a loading location of the processing-target package and further reaches a delivery location of the processing-target package from the loading location.

Then, the control part 20 obtains costs for the searched route by the function of the cost obtaining part 21c (step S220). Namely, the control part 20 identifies an energy cost per unit travel distance of the delivery vehicle by referring to the cost information 30a. In addition, the control part 20 identifies a distance along the route obtained at step S215. Furthermore, the control part 20 obtains a travel cost for the route by the product of the energy cost per unit travel distance of the delivery vehicle and the distance of the route.

Furthermore, the control part 20 identifies a section whose gradient magnitude exceeds a predetermined range from the route obtained at step S215 by referring to the map information 30b, and identifies a distance of the section. In addition, the control part 20 obtains an increase (rate) in travel cost caused by the gradient by referring to the cost information 30a, multiplies the distance of the section whose gradient magnitude exceeds the predetermined range by the rate, and thereby obtains a cost for the increase. Furthermore, the control part 20 identifies a curved section whose radius of curvature is less than or equal to a threshold value from the route obtained at step S215 by referring to the map information 30b, and identifies a distance of the curved section. In addition, the control part 20 obtains an increase (rate) in travel cost caused by the curve by referring to the cost information 30a, multiplies the distance of the curved section whose radius of curvature is less than or equal to the threshold value by the rate, and thereby obtains a cost for the increase. Furthermore, the control part 20 determines whether the route includes a toll road by referring to the cost information 30a, and when the route includes a toll road, the control part 20 obtains a toll for the toll road. Then, the control part 20 obtains an amount resulting from adding together the travel cost for the route, the increases in travel cost, and the toll, as costs required for delivery.

Then, the control part 20 obtains a profit by the function of the guidance control part 21d (step S225). Namely, the control part 20 identifies a delivery charge for the processing-target package based on the delivery information 303a, subtracts the costs obtained at step S220 from the delivery charge, and considers the resulting amount to be a profit for the processing-target package.

On the other hand, if it is determined at step S210 that there is an existing route, the control part 20 obtains costs for the existing route by the function of the cost obtaining part 21c (step S230). Namely, the control part 20 identifies an energy cost per unit travel distance of the delivery vehicle by referring to the cost information 30a, multiplies the distance of the existing route by the energy cost, and thereby obtains a travel cost. Furthermore, the control part 20 identifies a section whose gradient magnitude exceeds a predetermined range and a curved section whose radius of curvature is less than or equal to a threshold value from the existing route by referring to the map information 30b, and obtains increases in travel cost based on the distances of the sections. Furthermore, the control part 20 determines whether the existing route includes a toll road by referring to the cost information 30a, and when the existing route includes a toll road, the control part 20 obtains a toll for the toll road. Then, the control part 20 obtains an amount resulting from adding together the travel cost for the route, the increases in travel cost, and the toll, as costs required for delivery.

Then, the control part 20 performs a route search with the loading location and delivery location of the candidate package being stopping locations, by the function of the cost obtaining part 21c (step S235). Namely, by referring to the map information 30b, the control part 20 searches, based on the link costs, for a route (new route) having destinations of the existing route and having the loading location and delivery location of the processing-target package as destinations.

Then, the control part 20 obtains costs for the new route by the function of the cost obtaining part 21c (step S240). Namely, the control part 20 identifies an energy cost per unit travel distance of the delivery vehicle by referring to the cost information 30a, multiplies the distance of the new route by the energy cost, and thereby obtains a travel cost. Furthermore, the control part 20 identifies a section whose gradient magnitude exceeds a predetermined range and a curved section whose radius of curvature is less than or equal to a threshold value from the new route by referring to the map information 30b, and obtains increases in travel cost based on the distances of the sections. Furthermore, the control part 20 determines whether the new route includes a toll road by referring to the cost information 30a, and when the new route includes a toll road, the control part 20 obtains a toll for the toll road. Then, the control part 20 obtains an amount resulting from adding together the travel cost for the route, the increases in travel cost, and the toll, as costs required for delivery.

Then, the control part 20 obtains a profit for the new route and a profit for the existing route by the function of the guidance control part 21d (step S245). Namely, the control part 20 obtains, as a profit for the new route, an amount resulting from subtracting the costs for the new route from the total sum of delivery charges for all packages including the processing-target package (the total sum of delivery charges for all packages delivered on the existing route+a delivery charge for the processing-target package). In addition, the control part 20 obtains, as a profit for the existing route, an amount resulting from subtracting the costs for the existing route from the total sum of delivery charges for all packages delivered on the existing route.

Then, the control part 20 obtains a difference in profit by the function of the guidance control part 21d (step S250). Namely, the control part 20 subtracts the profit for the new route from the profit for the existing route which is obtained at step S245, and obtains the resulting amount as a difference in profit. Then, the control part 20 obtains a difference in time between the new route and the existing route (step S255). Namely, the control part 20 obtains required time periods for traveling each of the new route and the existing route by referring to the map information 30b. The required time periods may be obtained by various techniques, and for example, a required time period can be obtained by obtaining a section's required time period by dividing the distance of each section included in a route by average vehicle speed of the sections, and obtaining the sum of required time periods for the sections of the entire route. Needless to say, for a method of obtaining the required time period, various techniques may be used, and the average vehicle speed may vary depending on, for example, the traffic congestion level for each section. Then, the control part 20 obtains a difference in time by subtracting the required time period for the existing route from the required time period for the new route.

The pieces of information obtained in the above-described processes are associated with the processing-target package. For example, the profits obtained at step S225 and S245, the difference in profit obtained at step S250, and the difference in time obtained at step S255 are associated with the processing-target package.

Then, the control part 20 determines whether the processes have been done for all delivery candidate packages (step S260), and repeats the processes at and after step S207 until the control part 20 determines that the processes at step S207 to S260 have been done for all delivery candidate packages. If it is determined at step S260 that the processes have been done for all delivery candidate packages, then the control part 20 transmits profit information by the guidance control part 21d (step S265). Namely, the control part 20 transmits pieces of information such as profits (including a difference in profit, a difference in time, a new route, etc.) associated with each of the delivery candidate packages, to the matching server 300 through the communication part 40. The matching server 300 transmits the pieces of information to the driver terminal 200 at step S130.

### (4) Other Embodiments

The above-described embodiment is an example for implementing the present disclosure, and other various embodiments can also be adopted as long as guidance on information indicating a relationship between costs for a delivery candidate package and a delivery charge is provided. For example, notifications shown in FIGS. 4A to 4C are examples and other modes may be employed. For example, when there is an existing route, guidance on a profit for the existing route and a profit for a new route may be provided.

Furthermore, a part of the content of a notification may be omitted or other information may be added. For example, guidance provided on the guidance part may include a profit per unit distance which is obtained by dividing a profit by the distance of a route. This configuration can be implemented by, for example, changing the processes of the above-described embodiment. Specifically, after step S225, the control part 20 obtains the total distance of a searched route which is obtained at step S220 by referring to the map information 30b. Then, the control part 20 divides a profit obtained at step S225 by the total distance of the searched route, and thereby obtains a profit per unit distance. In addition, after step S255, the control part 20 obtains the total distance of a new route which is obtained at step S235, by referring to the map information 30b. Then, the control part 20 divides a profit for the new route which is obtained at step S245 by the total distance of the new route, and thereby obtains a profit per unit distance.

In a case of this configuration, the control part 20 transmits the profit per unit distance to the matching server 300 at step S265. The matching server 300 transmits the profit per unit distance to the driver terminal 200. As a result, in the driver terminal 200, the profit per unit distance for a case of accepting delivery of a delivery candidate package is outputted. For example, in the examples shown in FIGS. 4B and 4C, a profit per unit distance is displayed so as to be associated with a package. According to this configuration, it becomes easier for the driver to select a package with which a profit can be efficiently made, based on the profit per unit distance.

In addition, guidance provided on the guidance part may include a profit per unit time which is obtained by dividing a profit by a required time period required to travel a route. This configuration can be implemented by, for example, changing the processes of the above-described embodiment. Specifically, after step S225, based on the total distance of a searched route which is obtained at step S220 by referring to the map information 30b, the control part 20 obtains a required time period required to travel the searched route based on, for example, average vehicle speed. Then, the control part 20 divides a profit obtained at step S225 by the required time period for the searched route, and thereby obtains a profit per unit time. In addition, after step S255, the control part 20 divides a profit for a new route which is obtained at step S245 by a required time period for the new route which is obtained at step S255, and thereby obtains a profit per unit time.

In a case of this configuration, the control part 20 transmits the profit per unit time to the matching server 300 at step S265. The matching server 300 transmits the profit per unit time to the driver terminal 200. As a result, in the driver terminal 200, the profit per unit time for a case of accepting delivery of a delivery candidate package is outputted. For example, in the examples shown in FIGS. 4B and 4C, a profit per unit time is displayed so as to be associated with a package. According to this configuration, it becomes easier for the driver to select a package with which a profit can be efficiently made, based on the profit per unit time.

Needless to say, the configuration may be such that both of a profit per unit distance and a profit per unit time are displayed. Furthermore, the configuration may be such that as a search condition, at least either one of a profit per unit distance and a profit per unit time can be specified, and packages that match these profits may serve as candidates. Furthermore, the search conditions are not limited to those in the above-described example, and for example, the configuration may be such that as a search condition, a profit can be specified. In this case, packages that match a profit set as a search condition are displayed as candidates.

Each system included in the above-described embodiment may include a smaller number of apparatuses that share functions. Such an example includes an example in which at least one system shown in FIG. 1 is composed of the same apparatus as another system or other systems. For example, the delivery candidate proposal system 10 and the matching server 300 may be composed of a single piece apparatus. In addition, the delivery candidate proposal system 10, the matching server 300, and the driver terminal 200 may be composed of a single piece apparatus. Furthermore, the delivery candidate proposal system 10, the matching server 300, and the shipper terminal 100 may be composed of a single piece apparatus. Furthermore, the systems shown in FIG. 1 may be composed of a larger number of systems. For example, the matching server 300 or the delivery candidate proposal system 10 may be composed of a cloud server.

In addition, at least one of parts (the current location obtaining part 21a, the delivery information obtaining part 21b, the cost obtaining part 21c, and the guidance control part 21d) included in the delivery candidate proposal system 10 may be present separated into a plurality of apparatuses. Furthermore, a configuration in which some configurations of the above-described embodiment are omitted or a configuration in which processes are changed or omitted can also be assumed. For example, a configuration may be implemented in which a profit obtaining process is performed in either one of a case in which there is an existing route and a case in which there is no existing route.

The current location obtaining part may be configured in any manner as long as the current location obtaining part can obtain a current location of the delivery vehicle. Namely, when movement of the delivery vehicle from a current location starts, costs start to be incurred, and thus, in order to identify a starting point for the incurrence of costs, a current location is to be obtained. The current location may be identified by various techniques, and may be obtained by a sensor included in a terminal mounted on the delivery vehicle or a terminal used by a user such as the driver, or may be inputted by the user.

In addition, the current location may be used for other purposes than computation of costs. For example, the current location may be used to narrow down delivery candidate packages. An example of such a configuration includes a configuration in which a package having a loading location whose distance from the current location exceeds a predetermined range is excluded from delivery candidates. Needless to say, for information for narrowing down delivery candidate packages, other various types of information may be used, and for example, a loading location or a delivery location may be used. In addition, a section including a loading location or a delivery location may be obtained as a desired section that the user desires, and a package that is delivered to a location in the desired section may serve as a delivery candidate.

The delivery information obtaining part may be configured in any manner as long as the delivery information obtaining part can obtain the loading location, delivery location, and delivery charge for a delivery candidate package. Namely, the delivery information obtaining part obtains information about a package required to compute costs incurred upon delivering the package. The delivery information obtaining part may be configured in any manner as long as the delivery information obtaining part can obtain the loading location, delivery location, and delivery charge for a package to compute costs, and needless to say, other information, e.g., the loading date and time or delivery date and time of the package, may be obtained.

A delivery charge may be any charge as long as the charge is compared with costs, and may be a charge paid to the user such as the driver or may be a charge paid by the shipper. These charges may be the same or may be different from each other. An example of the latter case includes an example in which a charge obtained by excluding expenses such as a fee for using the delivery candidate proposal system from a charge paid by the shipper is paid to the user such as the driver. A delivery charge may be obtained by obtaining information for computing the delivery charge (e.g., the size and weight of a package, a loading area, and a delivery area) and performing computation, or the configuration may be such that a computed delivery charge is obtained.

The cost obtaining part may be configured in any manner as long as the cost obtaining part can obtain, based on a current location, a loading location, and a delivery location, costs required when the user such as the driver delivers a delivery candidate package to the delivery location on the delivery vehicle. Namely, the cost obtaining part may be configured in any manner as long as the cost obtaining part can obtain costs required when the delivery vehicle travels from a current location to a loading location, a package is loaded, and the delivery vehicle travels from the loading location to a delivery location to deliver the package. The costs include a travel cost for allowing the delivery vehicle to travel, and needless to say, the costs may include other costs. The other costs may include, for example, accommodation fees incurred when the user such as the driver needs to stay over for delivery, food expenses, parking fees, maintenance costs for the delivery vehicle, and the cost of consumables. Furthermore, an amount to be allocated as costs may be determined in accordance with various rules, and for example, costs may be calculated, including costs for a route to return to a base (e.g., a parking lot where the delivery vehicle is parked) from a delivery location. Furthermore, the costs may vary depending on the traffic congestion or weather.

The guidance control part may be configured in any manner as long as the guidance control part can allow the guidance part to provide guidance on information indicating a relationship between costs and a delivery charge, with a delivery candidate package. Namely, the guidance control part may be configured in any manner as long as the guidance control part can provide guidance so that a profit made when a delivery candidate package is delivered can be grasped. Hence, guidance on a profit (a delivery charge−costs) may be provided, or guidance by which a profit can be grasped may be provided by showing both a delivery charge and costs. Examples of the latter case include display in which a bar chart showing a delivery charge and a bar chart showing costs are placed side by side, and display in which the bar charts are stacked on top of each other. Needless to say, the charts are not limited to bar charts and other modes, e.g., numerical representation, may be employed.

Furthermore, a technique for providing guidance on information indicating a relationship between costs and a delivery charge for a delivery candidate package as in the present disclosure is also applicable as a program or a method. In addition, a system, a program, and a method such as those described above may be implemented as a single apparatus or may be implemented using a component shared with each part included in the vehicle, and include various modes. In addition, changes can be made as appropriate, e.g., a part is software and a part is hardware. Furthermore, the disclosure may be embodied as a recording medium for a program that controls an apparatus. Needless to say, the recording medium for software may be a magnetic recording medium or may be a semiconductor memory, and any recording medium to be developed in the future can also be considered exactly in the same manner.

### REFERENCE SIGNS LIST

10: Delivery candidate proposal system, 20: Control part, 21: Delivery candidate proposal program, 21a: Current location obtaining part, 21b: Delivery information obtaining part, 21c: Cost obtaining part, 21d: Guidance control part, 30: Recording medium, 30a: Cost information, 30b: Map information, 40: Communication part, 100: Shipper terminal, 101: Communication part, 102: User I/F part, 200: Driver terminal, 201: Communication part, 202: User I/F part, 300: Matching server, 301: Communication part, 302: Control part, 303: Recording medium, 303a: Delivery information, 303b: Search condition information, 312: Matching program, and 320: Control part

1. A delivery candidate proposal system comprising:
a current location obtaining part that obtains a current location of a delivery vehicle;
a delivery information obtaining part that obtains a loading location, a delivery location, and a delivery charge for a delivery candidate package;
a cost obtaining part that obtains costs required when the delivery candidate package is delivered to the delivery location on the delivery vehicle, based on the current location, the loading location, and the delivery location; and
a guidance control part that allows a guidance part to provide guidance on information indicating a profit obtained by subtracting the costs from the delivery charge, with the delivery candidate package.

2. The delivery candidate proposal system according to claim 1, wherein the costs include a travel cost for a route that reaches the delivery location from the current location via the loading location, the travel cost being identified based on an energy cost per unit travel distance of the delivery vehicle.

3. The delivery candidate proposal system according to claim 2, wherein the costs include an increase from the travel cost based on a gradient of the route, a shape of the route, and a toll for the route.

4. The delivery candidate proposal system according to claim 2, wherein guidance provided by the guidance part includes a profit per unit distance obtained by dividing the profit by a distance of the route.

5. The delivery candidate proposal system according to claim 2, wherein guidance provided by the guidance part includes a profit per unit time obtained by dividing the profit by a required time period required to travel the route.

6. A delivery candidate proposal terminal comprising:
a current location transmitting part that transmits a current location of a delivery vehicle;
a receiving part that receives information indicating a relationship between costs and a delivery charge, and a delivery candidate package, the costs being obtained based on a loading location, a delivery location, and the delivery charge for the delivery candidate package, and being required when the delivery candidate package is delivered to the delivery location on the delivery vehicle; and
a guidance part that provides guidance on information indicating a profit obtained by subtracting the costs from the delivery charge, with the delivery candidate package.

7. A delivery candidate proposal terminal comprising:
a current location transmitting part that transmits a current location of a delivery vehicle;
a receiving part that receives information indicating a relationship between costs and a delivery charge, and a delivery candidate package, the costs being obtained based on a loading location, a delivery location, and the delivery charge for the delivery candidate package, and being required when the delivery candidate package is delivered to the delivery location on the delivery vehicle; and
a guidance part that provides guidance on information indicating a profit obtained by subtracting the costs from the delivery charge, with the delivery candidate package.

8.-10. (canceled)
